(19) United States
(12) Patent Application Publication
(10) Pub. No.: US 2007/0223327 A1
(43) Pub. Date: Sep. 27, 2007

(54) OPTICAL DISC DRIVE AND METHOD OF CONTROLLING ACTUATOR

(76) Inventor: Hiroshi NAKANE, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/684,817

(22) Filed: Mar. 12, 2007

(30) Foreign Application Priority Data
Mar. 24, 2006 (JP) 2006-083261

(51) Int. Cl. G11B 7/00

(52) U.S. Cl. 369/44.29; 369/44.35

(57) ABSTRACT

The present invention comprises a tracking actuator which drives an objective of a pickup emitting the laser beam, in accordance with a drive signal, a detector which detects or estimates a temperature variation putting an influence on a sensitivity of the tracking actuator, and a corrector which corrects the drive signal in accordance with information detected or estimated by a state detector.

### CROSS-REFERENCE TO RELATED APPLICATIONS

This application is based upon and claims the benefit of priority from prior Japanese Patent Application No. 2006-083261, filed Mar. 24, 2006, the entire contents of which are incorporated herein by reference.

### BACKGROUND OF THE INVENTION

1. Field of the Invention

The present invention relates to an optical disc drive and, more particularly, to an optical disc drive and an actuator controlling method, capable of correcting pickup drive control in response to temperature variation of the drive.

2. Description of the Related Art

As for a conventional technique of recording picture information, etc. on a label surface of an optical disc, as shown in, for example, Jpn. Pat. Appln. KOKAI Publication No. 2003-203348, a optical pickup is first moved to an arbitrary position by a stepping motor, to scan the optical disc in a radial direction with the optical pickup at the formation of picture information, since there is no track information on the label surface of the optical disc. If a fine movement is made with a moving resolution greater than a minimum moving resolution of the stepping motor, a laser beam is further moved to an arbitrary recording position by driving a tracking actuator.

When the picture information is recorded on the label surface of the optical disc by the above prior art, the laser beam is moved to an arbitrary recording position by driving the tracking actuator. The laser beam is required to move at a small movement amount with a good accuracy. However, the sensitivity of the tracking actuator is varied when the picture information recording starts and when a predetermined time has passed, and the recording accuracy is deteriorated due to temperature rise in a coil of the tracking actuator, an actuator magnet, etc.

### BRIEF SUMMARY OF THE INVENTION

The present invention has been accomplished to solve the above-described problems. The object of the present invention is to provide an optical disc drive and an actuator controlling method, capable of detecting the temperature variation which produces an influence on the sensitivity of the tracking actuator and executing tracking actuator control with a good accuracy when the surface of the optical disc having no track information is scanned.

To achieve this object, an aspect of the present invention is an optical disc drive, for emitting a laser beam on a label surface of an optical disc and recording information thereon. The optical disc drive, comprises an actuator which drives an objective lens of a optical pickup emitting the laser beam, in accordance with a drive signal, a detector which detects or estimates a temperature variation putting an influence on a sensitivity of the actuator on the drive signal, and a corrector which corrects the drive signal in accordance with information detected or estimated by the detection means.

Thus, the present invention can provide an optical disc drive and an actuator controlling method, capable of detecting the temperature variation which produces an influence on the sensitivity of the tracking actuator and executing tracking actuator control with a good accuracy when the surface of the optical disc having no track information is scanned.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration showing a notebook-type personal computer equipped with an optical disc drive according to an embodiment of the present invention;

FIG. 2 is an illustration showing an outer appearance of the optical disc drive according to the embodiment of the present invention;

FIG. 3 is an illustration showing a state in which a drawer is ejected from the optical disc drive shown in FIG. 2;

FIG. 4 is a block diagram showing an entire configuration of the optical disc drive according to the embodiment of the present invention;

FIG. 5 is a block diagram showing main components of the optical disc drive according to the embodiment of the present invention;

FIG. 6 is an illustration showing a drive voltage of a focus actuator and a relationship in distance between the optical disc and an objective;

FIG. 7 is an illustration showing a principle of driving the focus actuator;

FIG. 8 is an illustration showing measurement of displacement of the tracking actuator in a case where a voltage is applied to the focus actuator;

FIG. 9 is an illustration showing measurement of influences of resistance variation in a case where a voltage is applied to the focus actuator;

FIG. 10 is an illustration showing a circuit of correcting the sensitivity of the tracking actuator according to the embodiment of the present invention;

FIG. 11 is an illustration showing a circuit of correcting the sensitivity of the tracking actuator according to another embodiment of the present invention; and

FIG. 12 is an illustration showing a circuit of correcting the sensitivity of the tracking actuator according to the other embodiment of the present invention.

### DETAILED DESCRIPTION OF THE INVENTION

Embodiments of the present invention will be explained below with reference to the accompanying drawings.

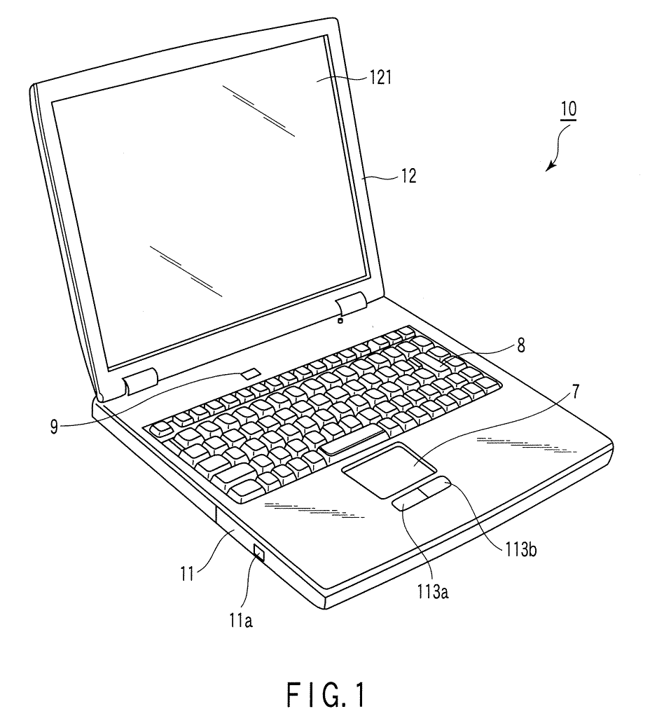

FIG. 1 shows a system configuration of an information processing apparatus according to a first embodiment of the present invention. This information processing apparatus is implemented as, for example, a notebook type personal computer 10.

The computer 10 is composed of a main body and a display unit 12 as shown in FIG. 1. A display screen 121 of an LCD (Liquid Crystal Display) is embedded in the display unit 12. The LCD display screen 121 is located substantially at the center of the display unit 12.

The display unit 12 is attached to the computer 10 so as to freely pivot between an opened position and a closed position. The computer 10 has a housing shaped in a thin box, and comprises a power button 9, an LED display unit (not shown) and a keyboard 8 on its top face, a touch pad 7, right and left buttons 113a and 113b, etc. on a palm rest, and an optical disc drive 11 on one of the side surfaces.

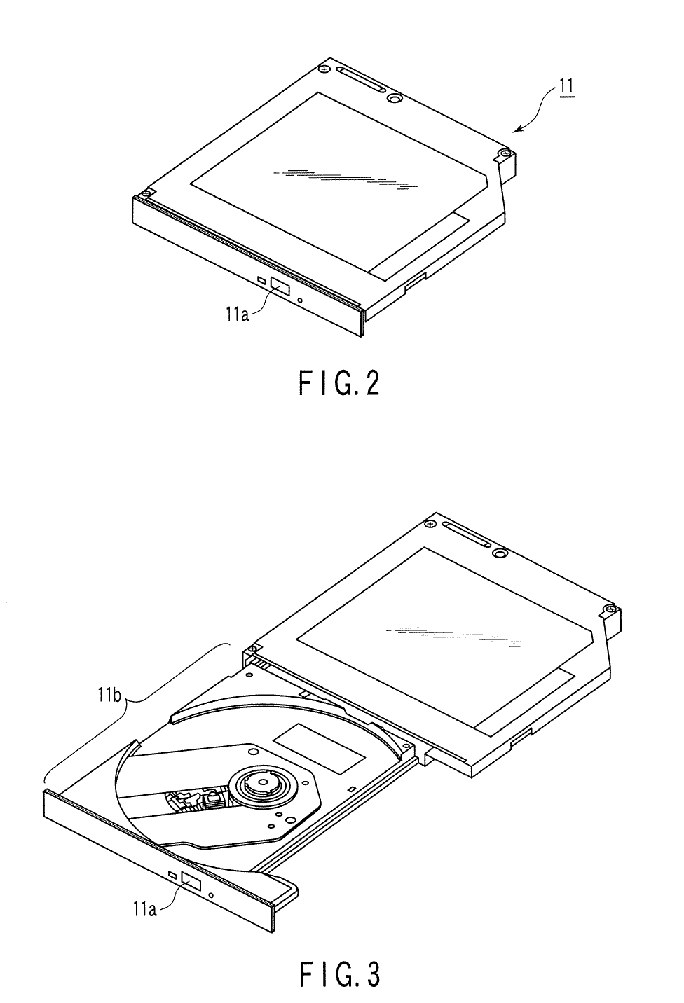

The optical disc drive 11 comprises an eject button 11a as shown in FIG. 2. By pushing down the eject button 11a, a drawer 11b is ejected as shown in FIG. 3.

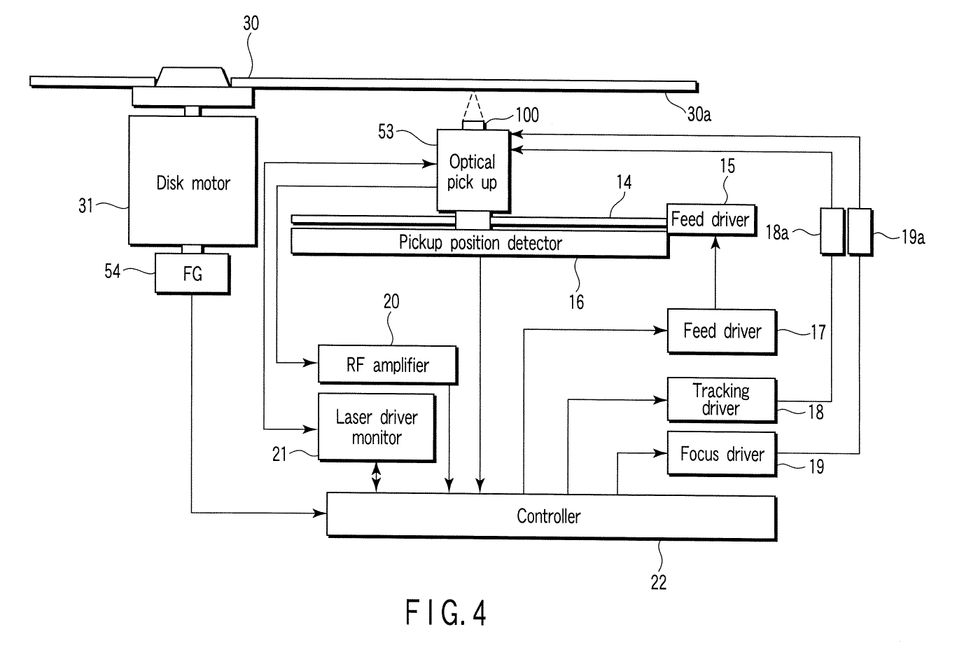

FIG. 4 is a block diagram showing a configuration of the optical disc drive according to the present invention.

An optical disc 30 set in the optical disc drive 11 is an optical disc capable of recording user data or a read-only optical disc. In this embodiment, the optical disc 30 is explained as an optical disc capable of recording user data. As the optical disc 30, a DVD-RAM of the land and groove recording is employed. However, the optical disc 30 is not limited to this but may be any optical disc having a recordable label surface.

The optical disc 30 is mounted on a disc motor 31 such that the label surface 30a faces an optical pickup 53. The disc motor 31 is controlled to rotate in accordance with commands of a controller (CPU) 22 such that a frequency of a pulse signal of an motor revolution pulse output unit (FG) 54 becomes a predetermined value. This predetermined value is varied in accordance with a radially recording position of the optical disc 30. Recording is thereby executed under CLV (Constant Linear Velocity) control.

The optical pickup 53 is a two-axis actuator which can move an object lens 100 in a focus direction and a track direction. The optical pickup 53 is driven by a tracking actuator 18a and a focus actuator 19a. The tracking actuator 18a and the focus actuator 19a are driven by a tracking driver 18 and a focus driver 19, respectively, on the basis of commands from the controller 22. These actuators 18a, 19a has been physically installed in the optical pickup 53, for example, a moving coil type in which magnets are fixed.

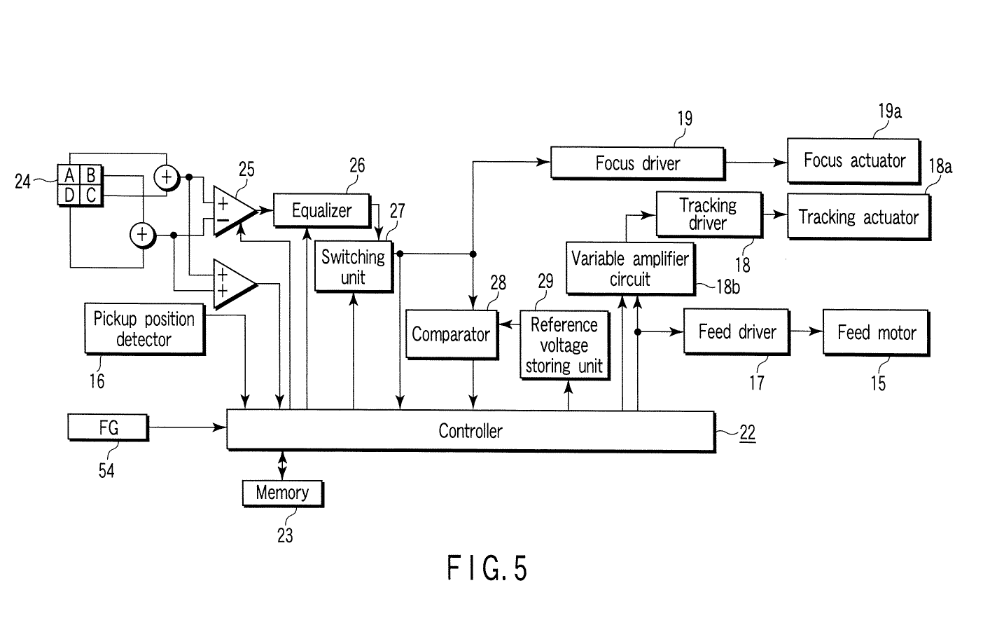

In addition, the optical pickup 53 comprises a optical detector 24 (showing FIG. 5.) for monitoring an emitted light beam of the semiconductor laser. The optical detector detecting a reflected light beam from the optical disc 30 has a multisegment structure, and necessary operations are executed by an RF amplifier 20.

The optical pickup 53 also comprises a pickup position detector 16. The pickup position detector 16 is, for example, a linear sensor, which detects radial position information on the label surface 30a of the optical disc 30. The position information detected by the pickup position detector 16 is transmitted to the controller 22. The controller 22 compares the position information with a target position and detects a position error signal, drives a feed motor 15 via a feed driver 17 so as to decrease the value of the position error signal, converts the rotational motion of the feed motor 15 into the linear motion by a lead screw 14 and moves the optical pickup 53. At this time, the optical pickup 53 cannot be moved via the lead screw 14 by the feed motor 15 so as to decrease the error between the position information and the target information to zero, for the reason such as, mainly, rattle. If the feed motor 15 is constituted by a stepping motor, the error is inclined to become greater due to influences such as friction, etc. If the error is, for example, approximately 100 μm, it may be greatly varied due to influences such as the temperature, aging, etc.

To avoid the influences, the controller 22 supplies the position error signal at an appropriate degree of amplification to the tracking driver 18 and controls the tracking actuator 18a to adjust the position of the laser spot from the optical pickup 53 onto the target position. Since the present embodiment does not comprise means for detecting the position of the laser spot, the occurring error depends on the above degree of amplification and the sensitivity of the tracking actuator 18a.

The picture information from a host controller (not shown) are transmitted to the controller 22 via a predetermined interface. On the basis of the transmitted the picture information, a laser beam is irradiated from the optical pickup 53 onto the label surface 30a via a laser driver monitor 21, by the controller 22, in accordance with the angle of rotation and the radial position of the optical disc 30, and the pictures, etc. are thereby formed thereon.

FIG. 5 is a block diagram for explanation of the correction to the sensitivity variation of the tracking actuator 18a.

First, the focus control of the present embodiment is described. In the present embodiment, astigmatism is employed for the focus error detecting method of the optical pickup 53.

The laser beam emitted from the optical pickup 53 is reflected at the optical disc 30 and projected on the optical detector 24. The optical detector 24 has a divided structure and is divided into, for example, four areas A, B, C, D as shown in the figure.

A signal obtained by summing up signals of divisional areas A and C of the optical detector 24 is input to a plus side of an operational amplifier 25. A signal obtained by summing up signals of divisional areas B and D of the optical detector 24 is input to a minus side of the operational amplifier 25. The signal from the operational amplifier 25 is transmitted to the focus driver 19 through switching unit 27, via an equalizer 26 configured to stabilize the position control of phase compensation, etc. The focus control is executed by driving the focus actuator 19a to move the object lens 100. The controller 22 is connected to the pickup position detector 16, the FG 54, a memory 23 configured to store the picture information corresponding to one rotation of the optical disc 30, the switching unit 27, a comparator 28, reference voltage storing unit 29, a variable amplifier circuit 18b, the feed driver 17, etc.

When the write data is recorded and reproduced on the data recording surface of the optical disc 30, the switching unit 27 is controlled by the controller 22 such that the focus actuator 19a is driven on the basis of a focus error signal generated by the operational amplifier 25. A focus servo loop is thereby formed.

On the other hand, when the picture information is recorded on the label surface 30a of the optical disc 30, the focus control employs the same optical system as that in a case of recording the information on the above optical disc 30. For this reason, a center of a focus error signal and a maximum point of the laser beam are offset due to the optical aberration, at a focal point of the laser beam on the optical disc 30. The maximum point of the reflected beam is the focus where recording can be executed most efficiently. Since the focus error signal is thus offset, stability of the focus servo in a closed loop cannot be maintained. In addition, the surface of the optical disc 30 is a portion where the picture information is recorded, but is easily blemished. Therefore, the profile irregularity of the optical disc surface is poor and has an influence on detection of the focus error. Even at the maximum point of the reflected beam, the optical beam is condensed at a condensation spot size of approximately 20 μm due to the optical aberration. On this account, the focus depth also becomes approximately 20 μm and the accuracy of the focus control may be rough to some extent. Therefore, open loop control is employed.

Next, a learning function of the focus drive signal is described. The focus servo is activated at a focus error signal center after varying the operation ratio of the operation amplifier 25, and data equivalent to one rotation of the optical disc 30, relating to the input signal of the focus driver 19, is recorded in the memory 23 at a timing corresponding to the picture information from the FG 54. The data equivalent to one rotation of the optical disc 30 is preferably recorded as, for example, data from which unnecessary high frequency components are removed with a predetermined filter, etc. Thus, the heat of the focus actuator 19a can be reduced.

Next, the function of the open loop focus servo is described. When the picture information is recorded in the label surface 30a of the optical disc 30, the focus servo outputs the data equivalent to one rotation of the optical disc 30 recorded in the memory 23 by the switching unit 27 to the focus driver 19, in accordance with the timing information from the FG 54, at every rotation of the optical disc 30. At the output, the offset corresponding to the maximum point of the reflected beam is added to the data. If the radial position of the optical disc 30 is different, the difference between the data equivalent to one rotation of the optical disc 30 recorded in the memory 23 and the actual value becomes great. Thus, the controller 22 stops the processing, executes again the learning processing, and records the data equivalent to one rotation of the optical disc 30 in the memory 23.

Next, a processing of correcting the sensitivity variation of the tracking actuator 18a driven by the tracking driver 18 is described. The position error signal detected on the basis of the position information from the pickup position detector 16 and the target position is supplied to the feed driver 17 and the variable amplifier circuit 18b from the controller 22. On the basis of a detection result of a temperature variation detecting method to be described later, the controller 22 varies the amplification width of the variable amplifier circuit 18b and corrects the sensitivity of the tracking actuator 18a.

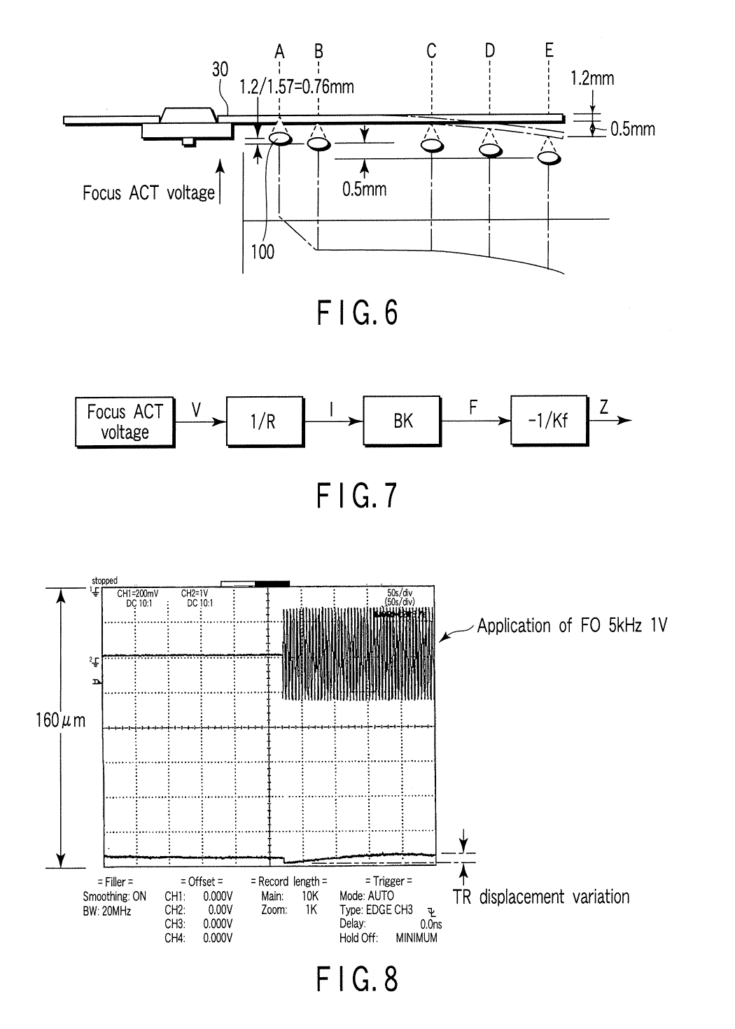

FIG. 6 is an illustration representing a relationship between the drive voltage of the focus actuator 19a and a distance from the object lens 100 moved up and down by the focus actuator 19a to the optical disc 30. In FIG. 6, warp of 0.5 mm occurs on the outer peripheral surface of the optical disc 30. The position in the disc radius direction of the disc of the object lens 100 at the recording on the optical disc 30 is represented by A to E.

Position A of the object lens 100 is a position where the data is generally recorded and reproduced on the data recording surface (information recording position). Positions B to E of the object lens 100 are positions where the picture information is recorded on the label surface 30a (label recording positions). Thus, if the thickness of the optical disc 30 is, for example, 1.2 mm, a difference between the data recording position and the label recording positions is approximately 0.76 mm. The refractive index is 1.57.

In FIG. 6, the drive voltage of the focus actuator 19a is represented by the vertical axis. If the position of the object lens 100 is different in the Positions A to E, the drive voltage of the focus actuator 19a is higher at the inner periphery of the optical disc 30.

FIG. 7 is an illustration explaining a principle of driving the focus actuator 19a and the tracking actuator 18a. To further simplify the explanation, a processing of the lower frequency area below the resonant frequency at the open loop control in the focus actuator 19a is explained alone. In the tracking actuator 18a, the same driving principle is employed.

If focus drive voltage V is applied to the focus actuator 19a, current I flows to the coil by resistance R of the moving coil. When the current I flows, force F proportional to magnetic flux density B and other constant K of the magnet occurs. When the force F is applied, displacement Z occurs at the objective due to spring constant Kf. The spring constant Kf actually is not constant. As the displacement Z becomes greater, the spring constant Kf increases.

When the sensitivity of the focus actuator 19a and the tracking actuator 18a are corrected, the variation of the spring constant Kf is preferably considered, too.

FIG. 8 is a graph showing actual measurement of the variation in the displacement (movement sensitivity) of the tracking actuator 18a in a case where a voltage of 5 kHz is applied at 1V to the focus coil (FO).

The graph indicates that when the tracking actuator 18a is displaced at, for example, approximately, 160 μm and the drive voltage is applied to the focus driver 19, the displacement of the tracking actuator 18a is decreased. In other words, it is understood that when the focus coil is heated, the tracking coil (TR) which is in close contact with the focus coil is heated, the resistance is increased, and the sensitivity of the tracking actuator 18a is degraded. When the above focus control is executed, it puts influences on the sensitivity of the tracking actuator 18a.

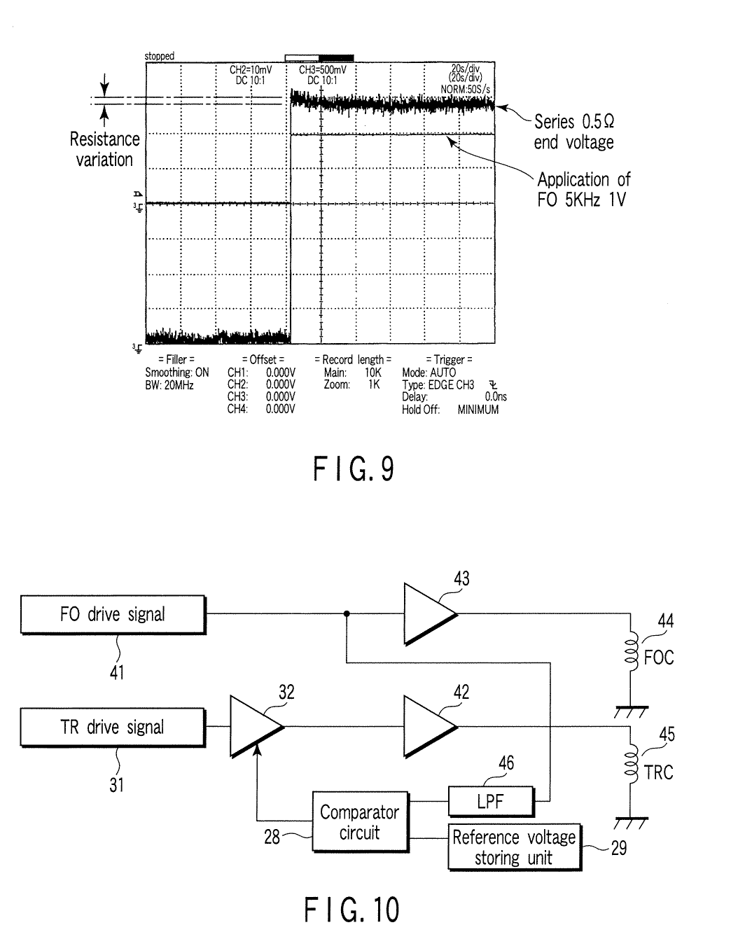

A result of verifying the heat generation of the focus coil is explained with reference to FIG. 9. FIG. 9 is a graph showing actual measurement of variation in the resistance of the focus actuator 19a. The graph shows a waveform in a case where a resistor of 0.5 Ω is connected serially to the focus coil and a FO drive signal of 5 kHz is applied at 1V to both ends of the focus coil. It can be understood from FIG. 9 that the end voltage of the focus coil having the resistance of 0.5 Ω lowers as the time passes. This means that heat is generated at the focus coil and the resistance is increased due to the thermal influence.

Next, correction of the sensitivity of the actuator 18a, 19a to the temperature variation is explained. The temperature coefficient of the coil (copper wire) of the actuator 18a, 19a are, for example, 0.393%/° C. The temperature coefficient of the magnetic flux density of the magnet (neodymagnet) of the actuator is, for example, −0.13%/° C. In this case, the temperature coefficient of the displacement sensitivity at the application of the voltage to the actuator is −0.523%/° C., on the assumption that the spring constant shows no temperature variation in the frequency range lower than the resonant frequency.

When the degree of amplification of the drive voltage applied to the actuator 18a, 19a for the temperature variation is adjusted and the sensitivity of the actuator 18a, 19a are corrected, the degree of amplification may be determined in the following formula. If the temperature coefficient of the sensitivity of the actuator 18a, 19a are represented as Kt (%/° C.), an initial value of the detected temperature is represented as T, the temperature after variation is represented as T1, an initial degree of amplification of the amplifier for sensitivity correction is represented as A and the corrected degree of amplification is represented as A1, the degree of amplification A1 after temperature variation (i.e. corrected) is:

A1=A[1−Kt(T1−T)/100]

FIG. 10 illustrates a circuit for correcting the sensitivity of the tracking actuator 18a. A focus (FO) drive signal 41 is applied to a focus drive coil (FOC) 44 via a power amplifier 43. A tracking (TR) drive signal 31 is applied to a tracking drive coil (TRC) 45 via a variable amplifier 32 and a power amplifier 42. A low frequency signal is taken from the FO drive signal 41 by a low-pass filter (LPF) 46 and is compared with a reference voltage stored in the reference voltage recording unit 29 by a comparator circuit 28, a degree of amplitude of the variable amplifier 32 is varied in accordance with a result of the comparison, and the TR drive signal 31 applied to the TRC 45 is thereby corrected. In other words, the sensitivity of the tracking actuator 18a is thereby corrected. The LPF 46 can also be implemented with, for example, a software processing by the controller 22. Since the sensitivity of the tracking actuator 18a is varied by heat, a driving condition of the adjacent FOC 44 which causes the heat to be generated is detected by monitoring the FO drive signal 41, and the sensitivity of the tracking actuator 18a is corrected in accordance with the drive of the FOC 44.

In such correction of the sensitivity of the tracking actuator 18a, the sensitivity does not need to be corrected at a real time. It is heat which should be compensated for by the correction of the sensitivity. The correction may be executed substantially at each 0.1 second since the response speed is low.

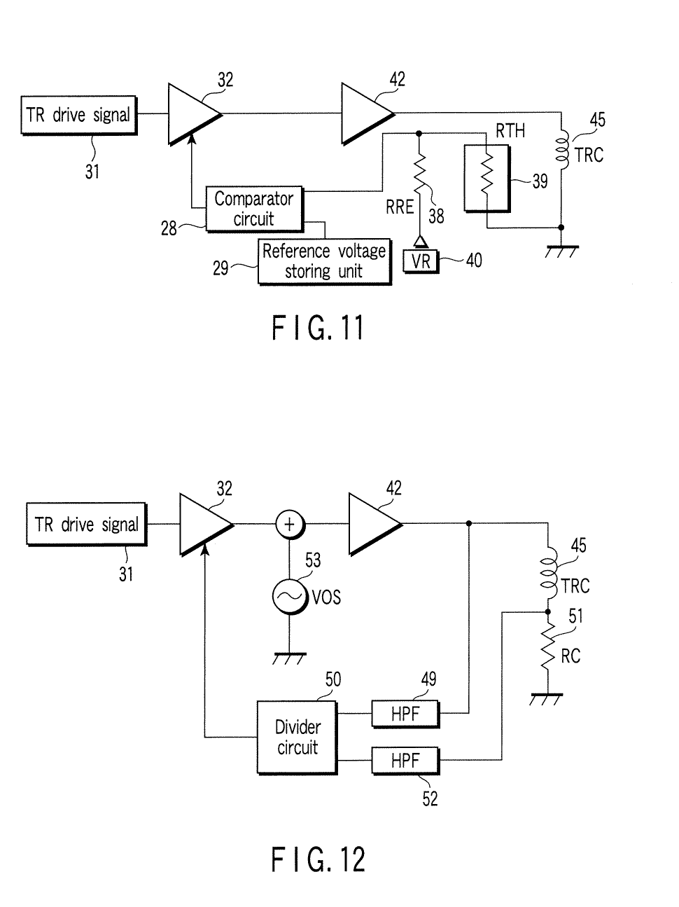

Next, FIG. 11 illustrates another circuit (another embodiment) for correcting the sensitivity of the tracking actuator 18a. A major difference to FIG. 10 is to detect the thermal influence on the tracking actuator 18a with a thermistor (RTH).

The TR drive signal 31 is applied to the TRC 45 via the variable amplifier 32 and the power amplifier 42. The TRC 45 is connected to the RTH 39, and a fixed power supply (VR) 40 and a resistor (RRE) 38 for generating the voltage are connected to the other end thereof. A voltage of the RTH 39 is compared with the reference voltage stored in the reference voltage storing unit 29 by the comparator circuit 28, and the degree of amplification of the variable amplifier 32 is varied in accordance with the comparison result. In other words, the temperature variation of the TRC 45 is directly detected with the RTH 39 and the sensitivity of the tacking actuator 18a is corrected on the basis of the detection result. The RTH 39 is desirably provided in the vicinity of the TRC 45 in order to detect the temperature of the TRC 45 with a good accuracy. However, the RTH 39 may be provided at any position inside the set housing since the RTH 39 has a mere ability of estimating the temperature of the tracking actuator 18a.

FIG. 12 illustrates the other circuit (other embodiment) for correcting the sensitivity of the tracking actuator 18a. A major difference to the embodiments shown in FIG. 10 and FIG. 11 is to control the width of amplitude of the variable amplifier 32 by using the resistance of the TRC 45.

The TR drive signal 31, i.e. the DC (direct current) signal passes through the variable amplifier 32, an alternate signal VOS 53 is added to the TR drive signal 31, and the TR drive signal 31 is applied to the TRC 45 via the power amplifier 42. At this time, the VOS signal 53 is taken from the drive voltage of the power amplifier 42 by a high-pass filter (HPF) 49 and input to a divider circuit 50. In addition, a VOS signal 53 from a current detection resistor (RC) 51 is taken by a HPF 52, and is input to the divider circuit 50.

In the divider circuit 50, the degree of amplification of the variable amplifier 32 is varied by discriminating a ratio of two input VOS signals 53, and the sensitivity of the tracking actuator 18a is thereby corrected. The frequency of the VOS signals 53 is desirably as high as possible to decrease the displacement of the tracking actuator 18a and enhance the sensitivity of detection. In the present embodiment, too, the amplitude width does not need to be corrected at a real time, similarly to the above embodiment.

According to each of the above embodiments, the sensitivity of the tracking actuator 18a can be corrected by detecting or estimating the temperature variation which puts influence on the sensitivity of the tracking actuator 18a and controlling the amplitude width of the tracking drive signal 31 in accordance with the temperature variation.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disc drive, for emitting a laser beam on a label surface of an optical disc and recording picture information thereon, comprising:
an actuator which drives an objective lens of a optical pickup emitting the laser beam, in accordance with a drive signal;
a detector which detects a temperature variation putting an influence on a sensitivity of the actuator on the drive signal;
and
a corrector which corrects the drive signal in accordance with information detected by the detector.

2. The optical disc drive according to claim 1, wherein the actuator is a tracking actuator and the detector estimates the temperature variation in accordance with the drive signal of the focus actuator driving the objective lens.

3. The optical disc drive according to claim 1, wherein the actuator is a tracking actuator and the detector detects the temperature variation by a temperature detection element.

4. The optical disc drive according to claim 1, wherein the actuator is a tracking actuator and the detector estimates the temperature variation by measuring a coil resistance of the tracking actuator.

5. A method of controlling an actuator of an optical disc drive for emitting a laser beam on a label surface of an optical disc and recording picture information thereon, the method comprising:
moving an objective lens of a optical pickup emitting the laser beam in a radial direction of the optical disc, by a tracking actuator, in accordance with a drive signal;
detecting a temperature variation putting an influence on a sensitivity of the tracking actuator on the drive signal;
and
correcting the drive signal in accordance with the detected temperature variation information.

6. The method according to claim 5, wherein in the detection or estimation of the temperature variation, the temperature variation is estimated in accordance with the drive signal of the focus actuator driving the objective lens.

7. The method according to claim 5, wherein in the detection or estimation of the temperature variation, the temperature variation is estimated by a temperature detection element.

8. The method according to claim 5, wherein in the detection or estimation of the temperature variation, the temperature variation is estimated by measuring a coil resistance of the tracking actuator.

9. An optical disc drive, for emitting a laser beam from an optical pickup on a label surface of an optical disc and recording picture information thereon, comprising:
a focus actuator which moves an objective lens in the optical pickup in a focus direction;
a tracking actuator which moves the objective lens in the optical pickup in a radial direction;
a drive signal generator which receives a reflection detecting signal from the optical pickup and generates a focus drive signal of the focus actuator and a tracking drive signal of the tracking actuator; and
an amplifier which, upon recording the picture information, corrects an amplification width of the tracking drive signal in accordance with a signal of comparison between a low frequency signal generated from the focus drive signal and a predetermined reference voltage and supplies a drive signal to a tracking coil of the tracking actuator.

10. An optical disc drive, for emitting a laser beam from an optical pickup on a label surface of an optical disc and recording picture information thereon, comprising:
a focus actuator which moves an objective lens in the optical pickup in a focus direction;
a tracking actuator which moves the objective lens in the optical pickup in a radial direction;
a drive signal generator which receives a reflection detecting signal from the optical pickup and generates a focus drive signal of the focus actuator and a tracking drive signal of the tracking actuator;
a thermistor which detects a temperature of a tracking coil of the tracking actuator driven in accordance with the tracking drive signal; and
an amplifier which, upon recording the picture information, corrects an amplification width of the tracking drive signal in accordance with a signal of comparison between a voltage output in accordance with the temperature detected by the thermistor and a predetermined reference voltage and supplies a drive signal to the tracking coil.

11. An optical disc drive, for emitting a laser beam from an optical pickup on a label surface of an optical disc and recording picture information thereon, comprising:
a focus actuator which moves an objective lens in the optical pickup in a focus direction;
a tracking actuator which moves the objective lens in the optical pickup in a radial direction;
a drive signal generator which receives a reflection detecting signal from the optical pickup and generates a focus drive signal of the focus actuator and a tracking drive signal of the tracking actuator;
a tracking coil of the tracking actuator driven by a drive voltage obtained by adding an AC signal to the tracking drive signal;
a resistor which obtains an output voltage of the tracking coil; and
an amplifier which, upon recording the picture information, corrects an amplification width with a signal obtained by subtracting a high frequency component of the output voltage from a high frequency component of the drive voltage and supplies the drive signal to the tracking coil.
